(19) United States
(12) Patent Application Publication
(10) Pub. No.: US 2014/0306510 A1
(43) Pub. Date: Oct. 16, 2014

(54) Custom Wheel With Wooden Inserts

(71) Applicant: DeAnthony THOMAS, Kansas City, MO (US)

(72) Inventor: DeAnthony THOMAS, Kansas City, MO (US)

(21) Appl. No.: 13/861,616

(22) Filed: Apr. 12, 2013

(51) Int. Cl. B60B 7/00

(52) U.S. Cl. CPC B60B 7/0033
USPC 301/37.107

(57) ABSTRACT

An ornamental wheel which is used to enhance the aesthetics of a vehicle. The ornamental wheel having a wheel and a plurality of ornamental inserts. The wheel is custom made in order to offer a look that is unique to each vehicle. Each of the ornamental inserts having a wooden body that is constructed in a customized shape in order to provide a unique style and overall appearance to a individual's vehicle. In a first embodiment of the ornamental wheel, the plurality of ornamental inserts are permanently connected to the wheel. In a second embodiment of the ornamental wheel, the plurality of ornamental inserts are removably attached to the wheel, allowing inserts of different colors to be interchanged.

### FIELD OF THE INVENTION

The present invention relates generally to automobile wheels. More specifically, the present invention is an ornamental wheel with wooden inserts that are used to create unique styles and designs

### BACKGROUND OF THE INVENTION

Most cars can be seen as an extension of their owner's personality, whether intended or not. For example, whether or not an individual maintains a clean interior or exterior of their car projects an image of the individual's priorities, level of care, laziness, motivation, etc. It is also common for aftermarket parts to be purchased in order to enhance one's car, namely performance parts and aesthetic parts. Performance parts are often purchased in order to improve upon features of the car, such as to provide additional horsepower or torque or to reduce the overall weight of the vehicle. In general, performance parts do not add anything to the overall look of the vehicle. Aesthetic parts, on the other hand, are you used to provide a unique look and style to one's vehicle and do not provide any improvements to the vehicles performance. Both interior and exterior aesthetic parts are manufactured, however, exterior parts have become popular as they can be viewed by the general public and not just those within the vehicle. Car rims in particular have become a popular method of showing off one's personality. Spinners, enlarged rims and chrome plating have all been used to enhance a car's wheels. While these are all popular wheel enhancements it is often desirable to provide additional flair to one's car wheels.

Therefore it is the object of the present invention to provide car wheels with unique styles and designs. The present invention provides customized car wheels with wooden inserts. The wooden inserts are shaped and sized to match the corresponding design of the car wheel. Additionally, the wooden inserts can be designed such that they are permanently held in place or such that they are removable.

### BRIEF DESCRIPTION OF THE DRAWINGS

FIG. 1 is a perspective view of the ornamental wheel in the preferred embodiment of the present invention.

FIG. 2 is a front elevational view of the ornamental wheel in the preferred embodiment of the present invention.

FIG. 3 is a rear elevational view of the ornamental wheel in the first embodiment of the present invention, having the plurality of ornamental inserts positioned within the plurality of cavities.

FIG. 4 is a rear elevational view of the ornamental wheel in the first embodiment of the present invention, having the plurality of ornamental inserts removed from the plurality of cavities.

FIG. 5 is an exploded view of the ornamental wheel in the first embodiment.

FIG. 6 is a right side sectional view of the ornamental wheel in the first embodiment.

FIG. 7 is a rear elevational view of the ornamental wheel in the second embodiment of the present invention, having the plurality of ornamental inserts positioned within the plurality of cavities.

FIG. 8 is an exploded view of the ornamental wheel in the second embodiment.

FIG. 9 is a right side sectional view of the ornamental wheel in the second embodiment.

FIG. 10 is a bottom elevational view of one of the plurality of ornamental inserts, in the preferred embodiment of the present invention.

### DETAIL DESCRIPTIONS OF THE INVENTION

All illustrations of the drawings are for the purpose of describing selected versions of the present invention and are not intended to limit the scope of the present invention.

The present invention is an ornamental wheel that is installed on a car or similar vehicle. The ornamental wheel is used to provide a unique style to the overall look of a user's vehicle. The ornamental wheel comprises a wheel 1 and a plurality of ornamental inserts 11. The wheel 1 is attached to a vehicle axle and supports a tire, thus allowing the vehicle to move. The plurality of ornamental inserts 11 are radially positioned around the wheel 1 and can be arranged in any number of different patterns in order to provide various designs and an overall unique appearance.

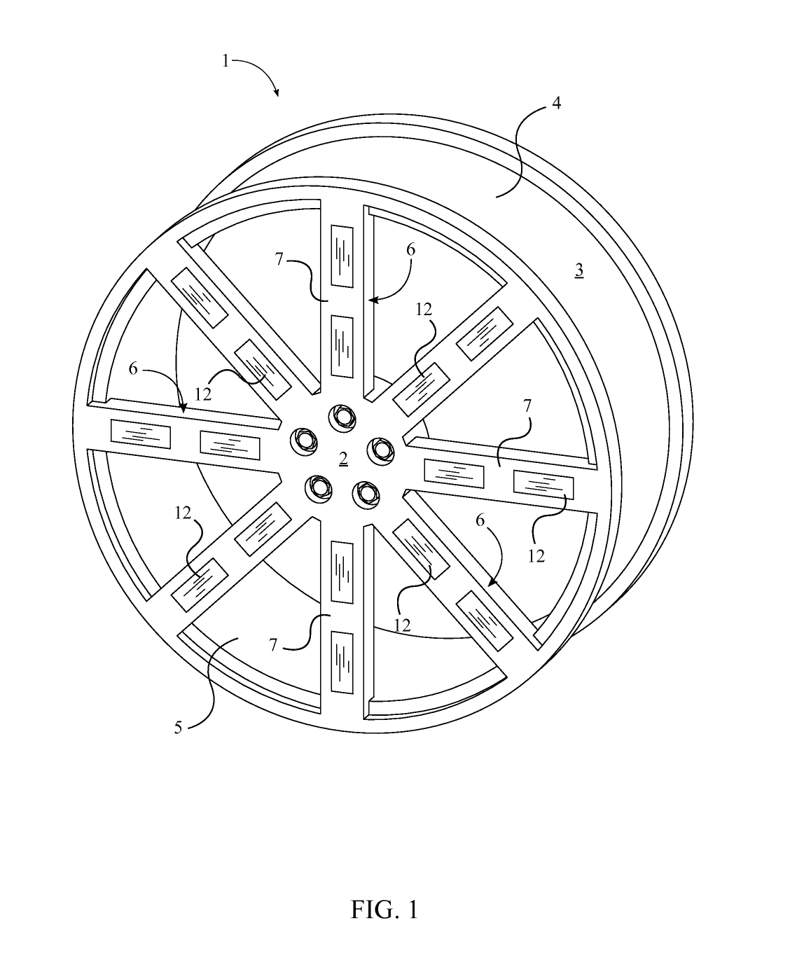

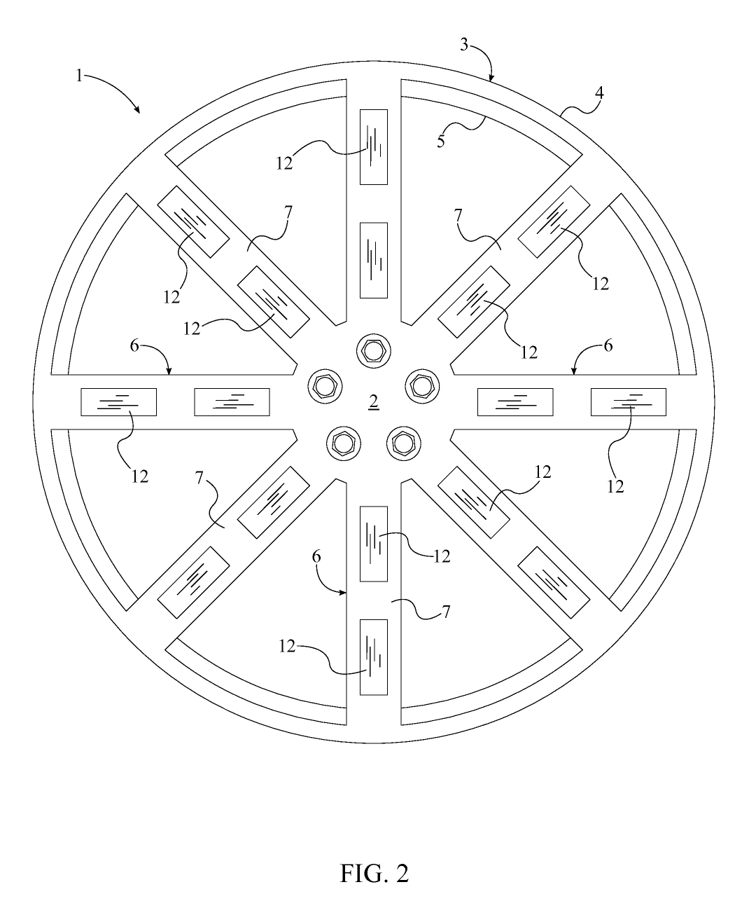

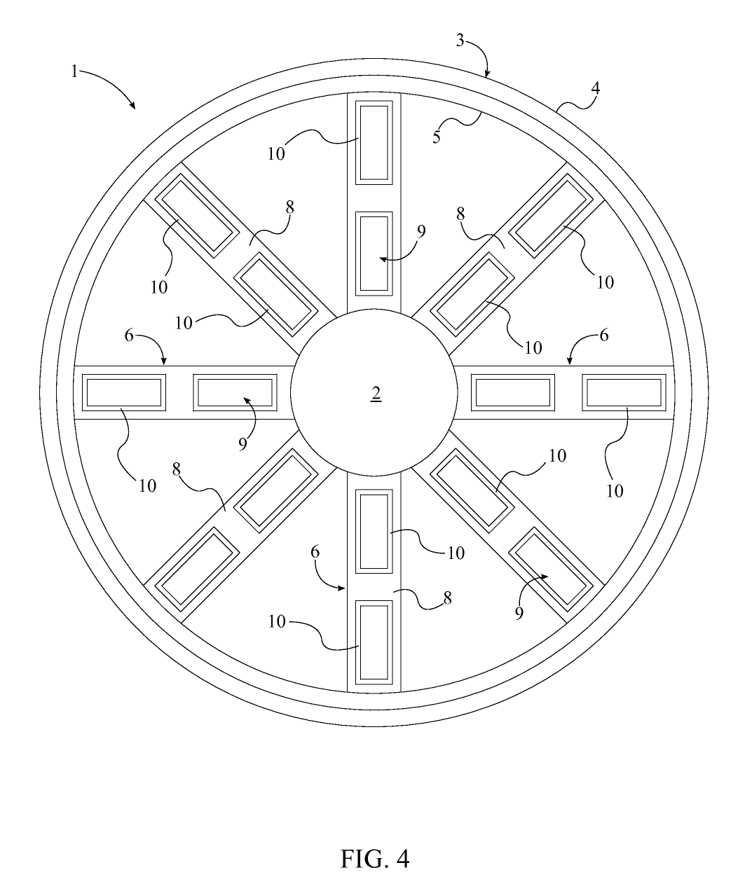

In reference to FIG. 1-9, the wheel 1 comprises a hub 2, a rim 3, and at least one radial spoke 6. In the preferred embodiment of the present invention, the wheel 1 is constructed from either steel or aluminum, however, it is possible for any other material or combination of materials to be used. The hub 2 is concentrically positioned within the rim 3 and provides a connection point between the wheel 1 and the vehicle axle. The rim 3 provides a connection point between the wheel 1 and the tire. The rim 3 comprises an outer surface 4 and an inner surface 5, with the outer surface 4 being positioned opposite of the inner surface 5 around the rim 3. The outer surface 4 provides a radial face to which the tire is attached, while the inner surface 5 provides a radial face to which the at least one radial spoke 6 is attached. The at least one radial spoke 6 is adjacently connected to both the hub 2 and the rim 3, and is positioned in between the hub 2 and the rim 3. In this way, the at least one radial spoke 6 acts as a support member, which connects the hub 2 and the rim 3. Each of the at least one radial spoke 6 can be constructed in any number of designs as to provide a distinct appearance to the ornamental wheel.

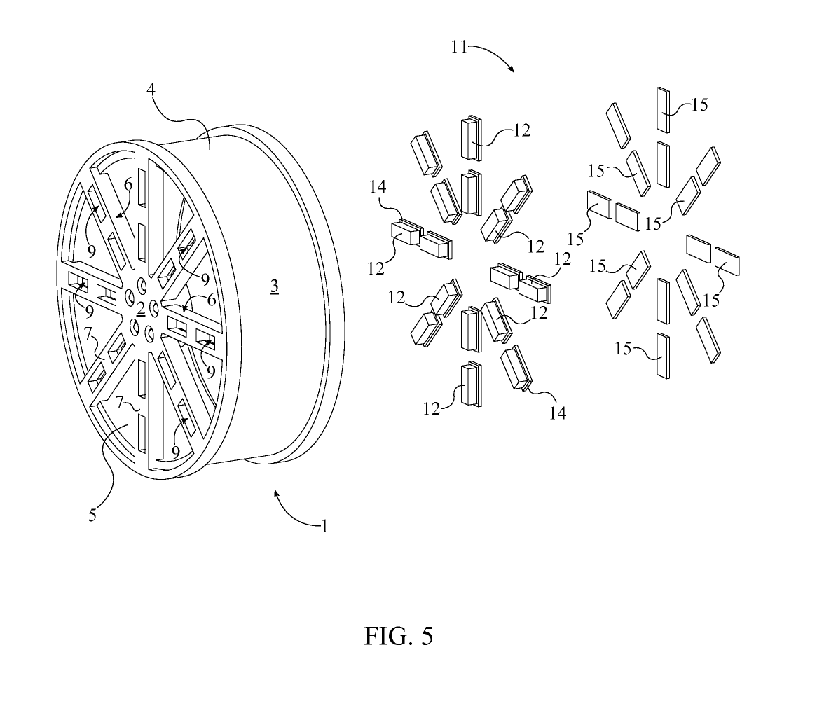

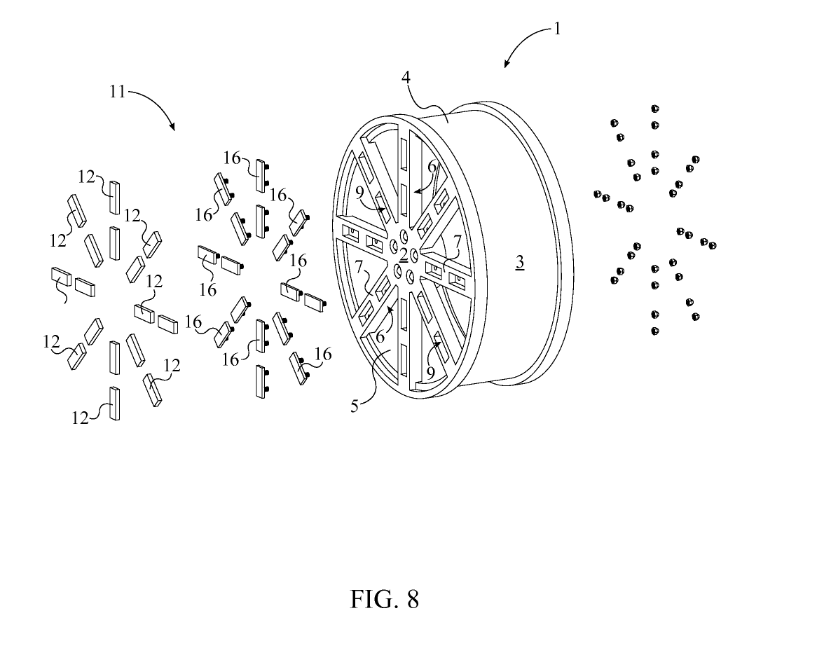

In reference to FIG. 5 and FIG. 8, the wheel 1 also comprises a plurality of cavities 9. Each of the plurality of cavities 9 is positioned with the at least one radial spoke 6. The plurality of cavities 9 can be positioned in any manner to reflect the design of the ornamental wheel. Each of the plurality of ornamental inserts 11 is positioned within the plurality of cavities 9. As such, each of the plurality of cavities 9 is a recess which is cut to the size and shape of the plurality of ornamental inserts 11. In this way, the plurality of cavities 9 provides a housing in which the plurality of ornamental inserts 11 are positioned and securely held in place.

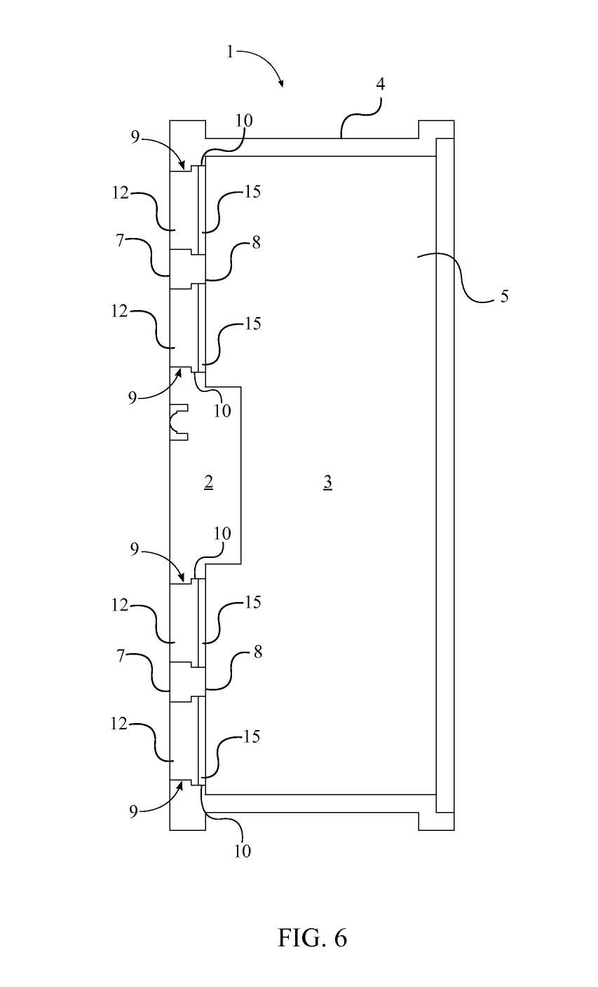

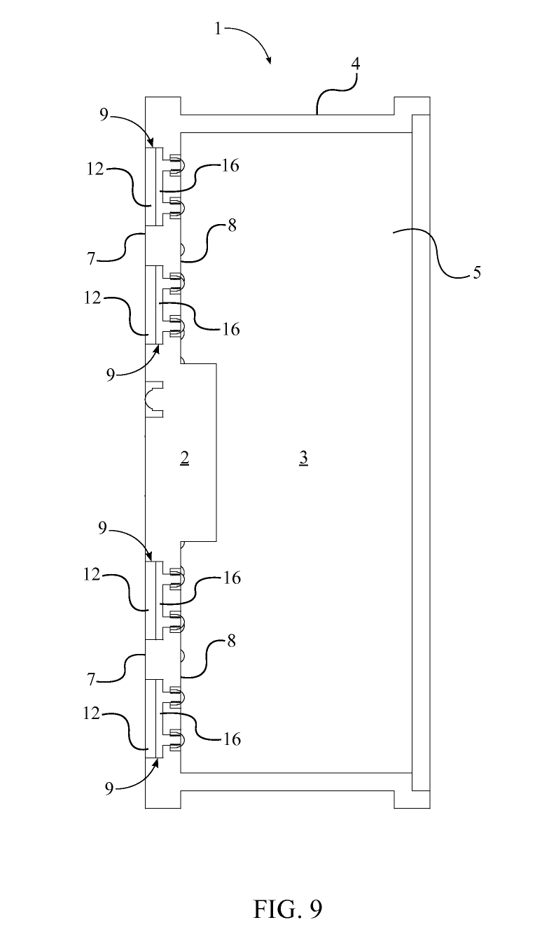

In reference to FIG. 6 and FIG. 9, each of the at least one radial spoke 6 comprises a front surface 7 and a rear surface 8, with the front surface 7 being positioned opposite of the rear surface 8 across the at least one radial spoke 6. The front surface 7 is the portion of the at least one radial spoke 6 along the front of the wheel 1 and can be seen by individuals when the ornamental wheel is attached to a vehicle. Additionally, the front surface 7 is used as a reference to position each of the plurality of ornamental inserts 11 within the plurality of cavities 9, namely to position each of the plurality of ornamental inserts 11 such that one side of each of the plurality of ornamental inserts 11 is flush with the front surface 7. The rear surface 8 is not visible to individuals when the ornamental wheel is attached to a vehicle as it is positioned along the back of the wheel 1. Similar to the front surface 7, the rear surface 8 is used as a further reference to position each of the plurality of ornamental inserts 11 within the plurality of cavities 9, namely to position each of the plurality of ornamental inserts 11 such that one side of each of the plurality of inserts is flush with the rear surface 8.

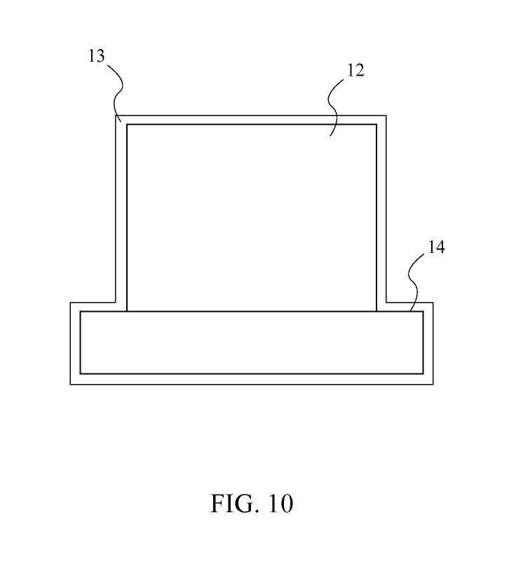

In reference to FIG. 10, each of the plurality of ornamental inserts 11 comprises a wooden body 12. In the preferred embodiment of the present invention, the wooden body 12 is constructed from nardi wood, however, it is possible for any other type of wood to be used. The wooden body 12 provides a decorative appearance to the ornamental wheel. The wooden body 12 can be any color and can be cut in any number of shapes and sizes. The wooden body 12 comprises a clear coat 13. The clear coat 13 encompasses the wooden body 12 and acts to protect the appearance of the wooden body 12 by preventing any scratches from being made along the wooden body 12.

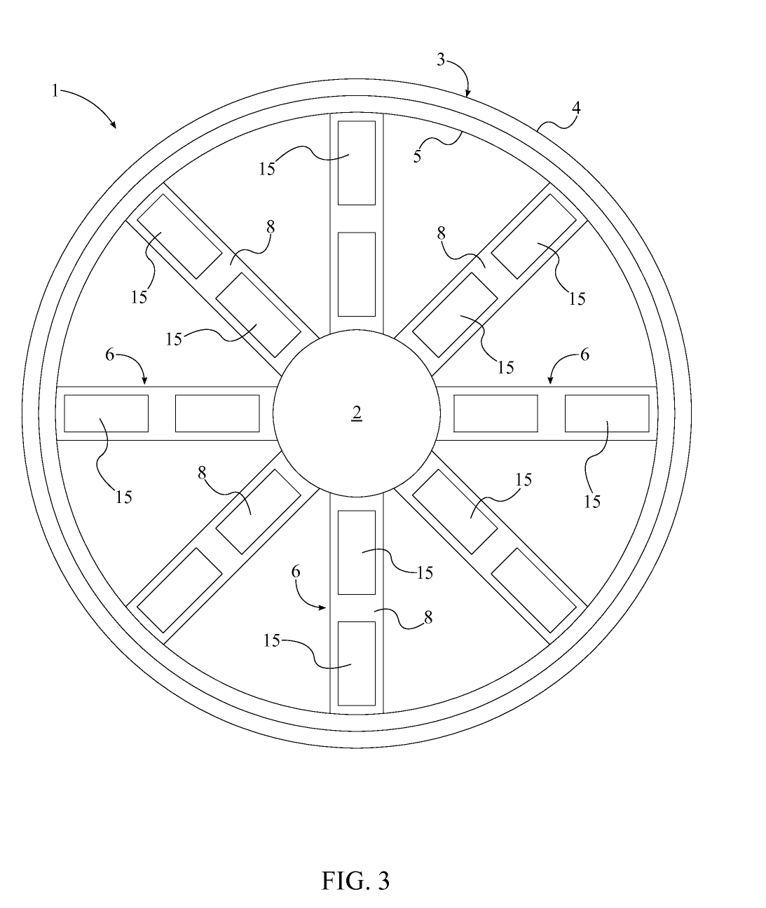

In reference to FIG. 3-6, in a first embodiment of the present invention, the plurality of ornamental inserts 11 is designed such that it is permanently connected to the wheel 1. In the first embodiment, each of the plurality of cavities 9 comprises a cavity lip 10, while the wooden body 12 further comprises a body lip 14. The cavity lip 10 is positioned along the rear surface 8 in addition to being positioned perimetrically around the plurality of cavities 9. The plurality of ornamental inserts 11 are placed into the plurality of cavities 9 through the rear surface 8 when the wheel 1 and the plurality of ornamental inserts 11 are assembled to form the ornamental wheel. The cavity lip 10 provides a surface to catch the plurality of ornamental inserts 11, preventing the plurality of ornamental inserts 11 from freely passing through the plurality of cavities 9. The body lip 14 is positioned perimetrically around the wooden body 12 and is adjacently connected to the cavity lip 10. In this way, the body lip 14 is the portion of the plurality of ornamental inserts 11 that comes in contact with the cavity lip 10, preventing the plurality of ornamental inserts 11 from freely passing through the plurality of cavities 9. The depth of the wooden body 12 and the depth of the plurality of cavities 9 are determined such that the wooden body 12 is positioned flush with the front surface 7 when the plurality of ornamental inserts 11 is positioned within the plurality of cavities 9.

In reference to FIG. 3 and FIG. 5-6, in the first embodiment of the present invention, each of the plurality of ornamental inserts 11 further comprises an end plate 15. The end plate 15 is positioned along the wooden body 12 opposite of the front surface 7 and is adjacently connected to the at least one radial spoke 6. In this way, the end plate 15 permanently secures the wooden body 12 within the plurality of cavities 9. Additionally, the side of the end plate 15 opposite of the wooden body 12 is positioned flush with the rear surface 8. This ensures that the plurality of ornamental inserts 11 does not interfere with the brake calipers of the vehicle.

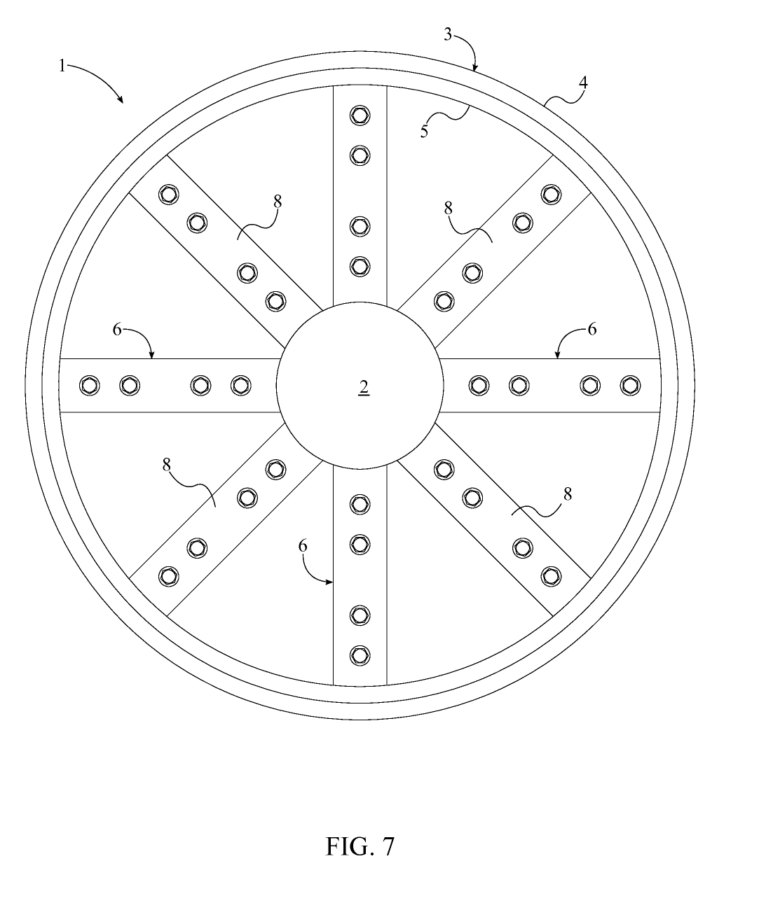

In reference to FIG. 7-9, in a second embodiment of the present invention, the plurality of ornamental inserts 11 is designed such that it is removably attached to the wheel 1. In the second embodiment of the present invention, each of the plurality of ornamental inserts 11 further comprises a metal plate 16. The metal plate 16 provides a base to which the wooden body 12 is permanently connected. The metal plate 16 is removably attached to the at least one radial spoke 6 opposite of the wooden body 12. In this way, each of the plurality of ornamental inserts 11 can be interchanged with the plurality of ornamental inserts 11 of a different color. In one method of attachment, at least one extrusion extends from the side of the metal plate 16 opposite of the wood body. The at least one extrusion provides a threaded connection to which a nut or similar object is used to secure the plurality of ornamental inserts 11 to the at least one radial spoke 6. In the second embodiment of the present invention, the plurality of ornamental inserts 11 is positioned within the plurality of cavities 9 through the front surface 7. The combined depth of the wooden body 12 and the metal plate 16 and the depth of the plurality of cavities 9 are determined such that the wooden body 12 is positioned flush with the front surface 7 when the plurality of ornamental inserts 11 is positioned within the plurality of cavities 9.

Although the invention has been explained in relation to its preferred embodiment, it is to be understood that many other possible modifications and variations can be made without departing from the spirit and scope of the invention as hereinafter claimed.

What is claimed is:

1. An ornamental wheel comprises:
a wheel;
a plurality of ornamental inserts;
the wheel comprises a hub, a rim, at least one radial spoke, and a plurality of cavities;
each of the plurality of ornamental inserts comprises a wooden body;
the rim comprises an outer surface and an inner surface;
each of the at least one radial spoke comprises a front surface and a rear surface;
the wooden body comprises a clear coat;
the clear coat encompassing the wooden body;
the hub being concentrically positioned within the rim;
the outer surface being positioned opposite of the inner surface around the rim;
the front surface being positioned opposite of the rear surface across the at least one radial spoke;
the at least one radial spoke being adjacently connected to the hub and the inner surface;
the at least one radial spoke being positioned in between the hub and the rim; and
each of the plurality of cavities being positioned with the at least one radial spoke.

2. The ornamental wheel claimed in claim 1 comprises:
each of the plurality of cavities comprises a cavity lip;
the wooden body further comprises a body lip;
each of the plurality of ornamental inserts further comprises an end plate;
the cavity lip being positioned perimetrically around the plurality of cavities;
the cavity lip being positioned along the rear surface;
the body lip being positioned perimetrically around the wooden body; and
each of the plurality of ornamental inserts being positioned within the plurality of cavities.

3. The ornamental wheel claimed in claim 2 comprises:
the body lip being adjacently connected to the cavity lip;
the wooden body being positioned flush with the front surface;
the end plate being adjacently connected to the at least one radial spoke;
the end plate being positioned along the wooden body opposite of the front surface; and
the end plate being positioned flush with the rear surface.

4. The ornamental wheel as claimed in claim 1 comprises:
each of the plurality of ornamental inserts further comprises a metal plate;
the wooden body being permanently connected to the metal plate; and
each of the plurality of ornamental inserts being positioned within the plurality of cavities.

5. The ornamental wheel as claimed in claim 4 comprises:
the metal plate being removably attached to the at least one radial spoke opposite of the wooden body; and
the wooden body being positioned flush with the front surface.

6. An ornamental wheel comprises:
a wheel;
a plurality of ornamental inserts;
the wheel comprises a hub, a rim, at least one radial spoke, and a plurality of cavities;
each of the plurality of ornamental inserts comprises a wooden body and an end plate;
the rim comprises an outer surface and an inner surface;
each of the at least one radial spoke comprises a front surface and a rear surface;
each of the plurality of cavities comprises a cavity lip;
the wooden body comprises a clear coat and a body lip;
the clear coat encompassing the wooden body;
the hub being concentrically positioned within the rim;
the outer surface being positioned opposite of the inner surface around the rim;
the front surface being positioned opposite of the rear surface across the at least one radial spoke;
the at least one radial spoke being adjacently connected to the hub and the inner surface;
the at least one radial spoke being positioned in between the hub and the rim; and
each of the plurality of cavities being positioned with the at least one radial spoke.

7. The ornamental wheel claimed in claim 6 comprises:
the cavity lip being positioned perimetrically around the plurality of cavities;
the cavity lip being positioned along the rear surface;
the body lip being positioned perimetrically around the wooden body;
each of the plurality of ornamental inserts being positioned within the plurality of cavities;
the body lip being adjacently connected to the cavity lip;
the wooden body being positioned flush with the front surface;
the end plate being adjacently connected to the at least one radial spoke;
the end plate being positioned along the wooden body opposite of the front surface; and
the end plate being positioned flush with the rear surface.

8. An ornamental wheel comprises:
a wheel;
a plurality of ornamental inserts;
the wheel comprises a hub, a rim, at least one radial spoke, and a plurality of cavities;
each of the plurality of ornamental inserts comprises a wooden body and a metal plate;
the rim comprises an outer surface and an inner surface;
each of the at least one radial spoke comprises a front surface and a rear surface;
the wooden body comprises a clear coat;
the clear coat encompassing the wooden body;
the hub being concentrically positioned within the rim;
the outer surface being positioned opposite of the inner surface around the rim;
the front surface being positioned opposite of the rear surface across the at least one radial spoke;
the at least one radial spoke being adjacently connected to the hub and the inner surface;
the at least one radial spoke being positioned in between the hub and the rim; and
each of the plurality of cavities being positioned with the at least one radial spoke.

9. The ornamental wheel as claimed in claim 8 comprises:
each of the plurality of ornamental inserts being positioned within the plurality of cavities;
the wooden body being permanently connected to the metal plate;
the metal plate being removably attached to the at least one radial spoke opposite of the wooden body; and
the wooden body being positioned flush with the front surface.
